(19) United States
(12) Patent Application Publication
(10) Pub. No.: US 2026/0204574 A1
(43) Pub. Date: Jul. 16, 2026

(54) INTERLAYER WITH METAL SALT, METHOD OF MAKING THE INTERLAYER, AND ANODELESS ALL-SOLID-STATE BATTERY INCLUDING THE INTERLAYER

(71) Applicant: SAMSUNG SDI CO., LTD., Yongin-si (KR)

(72) Inventors: Hoyoung Lee, Cambridge, MA (US); Catherine Haslam, Cambridge, MA (US); Yang Li, Cambridge, MA (US); Forrest S. Gittleson, Cambridge, MA (US); Singyuk Hou, Cambridge, MA (US); Yongseok Kim, Cambridge, MA (US); Seungman Park, Yongin-si (KR); Haena Yim, Yongin-si (KR); Juhee Sohn, Yongin-si (KR); Jaehou Nah, Yongin-si (KR)

(21) Appl. No.: 19/423,920

(22) Filed: Dec. 17, 2025

Related U.S. Application Data
(60) Provisional application No. 63/745,525, filed on Jan. 15, 2025.

(51) Int. Cl. H01M 4/62; H01M 10/052

(52) U.S. Cl. CPC H01M 4/62; H01M 4/622; H01M 4/625; H01M 4/626; H01M 10/052

(57) ABSTRACT

An anodeless all-solid-state battery (ASSB) and a method of making the anodeless ASSB are provided. The anodeless ASSB includes: a positive electrode, a negative electrode current collector, a solid-state electrolyte, and an interlayer including at least one additive, a carbonaceous material, and a binder. The additive may include a metal compound, nanoparticles, or a combination thereof, the metal compound may be represented by formula MₓA_{y} and the nanoparticles may include a metal represented by M of formula MₓA_{y}, x and y are integers independently selected from 1 to 6, M may be silver, zinc, indium, tin, bismuth, magnesium, aluminum, or a combination thereof, and A may be nitrate, sulfate, iodide, chloride, fluoride, or a combination thereof. The interlayer may be substantially free of organic amine compounds. A molar ratio of the metal compound to the nanoparticles may be about 100:1 to about 3:1.

### CROSS-REFERENCE TO RELATED APPLICATION

This application claims priority to and the benefit of U.S. Provisional Patent Application Ser. No. 63/745,525, filed on Jan. 15, 2025, the entire content of which is incorporated herein by reference.

### BACKGROUND AND FIELD

An all-solid-state battery (ASSB) is considered a next-generation energy storage system because it has potential to provide superior safety characteristics and higher energy density compared to a lithium-ion batteries (LIB). The ASSB includes a solid-state electrolyte to mitigate electrolyte leakage, thermal runaway, combustion, and other the safety issues associated with flammable solvents used in an LIB. Sulfide-based argyrodite materials including Li₆PS₆Cl, Li₆PS₆Br, Li₆PS₆I, and/or the like are promising solid-state electrolytes that have high ionic conductivity and favorable mechanical properties. Despite these advantages, ASSBs utilizing a lithium metal anode still face significant challenges, including dendrite formation, uneven lithium deposition, and interfacial instability, which may decrease Coulombic efficiency and battery cycle life.

An anodeless ASSB featuring no lithium metal on the anode current collector when manufactured is an efficient approach to increase energy density. Lithium metal is plated directly to the anode current collector during the first charge of the anodeless ASSB. This design simplifies cell structure but has disadvantages such as non-uniform lithium deposition, deposition of inactive (e.g., dead) lithium, and rapid interfacial degradation.

One strategy to overcome these challenges includes an interlayer between the anode current collector and the solid-state electrolyte that facilitates uniform lithium plating. Silver-carbon (AgC) composites are highly promising for use as an interlayer because silver forms alloys with lithium readily and reduces the energetic nucleation barrier, while carbon provides electronic conductivity and mechanical support. However, existing fabrication methodology of AgC interlayers require multiple synthetic procedures, organic additives, and complicated mixing processes that limit scalability and increase manufacturing costs.

The need exists for a simple and scalable approach to manufacture interlayers that promote stable lithium plating for anodeless ASSBs.

### SUMMARY

One or more aspects of embodiments of the present disclosure are directed toward an anodeless battery including an interlayer of carbon, a metal compound (e.g., inorganic metal salt), and metal nanoparticles.

One or more aspects of embodiments of the present disclosure are directed toward an interlayer having a ductile solid electrolyte interface with multi-ductility mechanisms provided by ductility promoters that enhance or increase the ductility of the interlayer. The ductility promoters may have metallic ductility, ionic crystal ductility, ceramic ductility, or combinations thereof each of which may accommodate volume expansion to reduce or prevent crack propagation. The ductility promoters may be formed by reaction of the metal compound with lithium during the initial charging process of the anodeless battery.

One or more aspects of embodiments of the present disclosure are directed toward a method of making the interlayer that includes preparing a slurry including a carbonaceous material and a metal compound followed by a mild heat treatment process. The relative amounts of unreduced metal compound and reduced metal nanoparticles in the interlayer may selected by the conditions used for the heat treatment process.

One or more aspects of embodiments of the present disclosure are directed toward a method of operating the anodeless battery.

Additional aspects of embodiments will be set forth in part in the description which follows and will be apparent from the description, or may be learned by practice of the presented embodiments of the disclosure.

One or more embodiments of the present disclosure provides an anodeless all-solid-state battery including: a positive electrode; a negative electrode current collector; a solid-state electrolyte between the positive electrode and the negative electrode current collector; and an interlayer between the solid-state electrolyte and the negative electrode current collector and including at least one additive, a carbonaceous material, and a binder, the additive including a metal compound, nanoparticles, or a combination thereof, the metal compound represented by formula MₓA_{y} and the nanoparticles including a metal represented by M of formula MₓA_{y}, wherein in formula MₓA_{y}, x and y are integers independently selected from 1 to 6, M may be silver (Ag), zinc (Zn), indium (In), tin (Sn), bismuth (Bi), magnesium (Mg), aluminum (Al), or a combination thereof, and A may be nitrate (NO₃⁻), sulfate (SO₄²⁻), iodide (I⁻), chloride (Cl⁻), fluoride (F⁻), or a combination thereof.

In one or more embodiments, the interlayer may be substantially free of organic amine compounds.

In one or more embodiments, the additive includes the metal compound and the nanoparticles and a molar ratio (R1) of the metal compound to the nanoparticles may be about 100:1 to about 3:1.

In one or more embodiments, the metal compound may be configured to form ductility promoters including a lithium metal alloy, at least one lithium compound, a reduced compound, or combinations thereof, the lithium metal alloy may be represented by formula Li-M^{AL}, the lithium compound may be represented by formula LiₐA_{b} or formula LiₘBₙ, the reduced compound may be represented by formula MₚB_{q}, M^{AL} may be silver (Ag), zinc (Zn), indium (In), tin (Sn), bismuth (Bi), magnesium (Mg), aluminum (Al), or a combination thereof, B may be nitride (N³⁻), sulfide (S²⁻), iodide (I⁻), chloride (Cl⁻), fluoride (F⁻), or a combination thereof, a, b, m, n, p and q are integers independently selected from 1 to 6, and M and A are as defined in formula MₓA_{y}.

In one or more embodiments, the metal compound may be configured to form the ductility promoters during operation of the battery and increase ductile properties of the interlayer.

In one or more embodiments, the ductility promoters may have ductile properties including metallic ductility, ionic crystal ductility, ceramic ductility, or combinations thereof.

In one or more embodiments, the metal alloy may have metallic ductility and the lithium compound, the reduced compound, or a combination thereof have ionic crystal ductility.

In one or more embodiments, the metal compound may be selected from among silver nitrate (AgNO₃), zinc nitrate (Zn(NO₃)₂), silver sulfate (Ag₂SO₄), zinc sulfate (ZnSO₄), silver iodide (AgI), zinc iodide (ZnI₂), silver chloride (AgCl), and zinc chloride (ZnCl₂).

In one or more embodiments, the ductility promoters may include silver sulfide (Ag₂S), lithium sulfide (Li₂S), lithium iodide (LiI), lithium chloride (LiCl), or a combination thereof.

In one or more embodiments, the Ag₂S, Li₂S, LiI, LiCl, or a combination thereof may have ionic crystal ductility.

In one or more embodiments, the metal compound may be silver sulfate (Ag₂SO₄) and may be configured to form a lithium-silver (Li—Ag) alloy, lithium sulfate (Li₂SO₄), lithium sulfide (Li₂S), silver sulfide (Ag₂S), or combinations thereof, the Li—Ag alloy may be configured to increase metallic ductility of the interlayer, and the Li₂S and the Ag₂S may each independently be configured to increase ceramic ductility and ionic conductivity of the interlayer simultaneously.

In one or more embodiments, the nanoparticles may consist of an elemental form of the metal having electronic conductivity and are on the carbonaceous material.

In one or more embodiments, at least a portion of the metal compound may be unreduced.

In one or more embodiments, the carbonaceous material may include amorphous carbon, graphite, graphene, reduced graphene oxide, carbon nanotube, or combinations thereof.

In one or more embodiments, the interlayer may include, based on a total weight of the interlayer: about 1 wt % to about 50 wt % of the at least one metal additive; about 5 wt % to about 95 wt % of the carbonaceous material; and about 1 wt % to about 30 wt % of a water-soluble binder.

In one or more embodiments, the interlayer may include a lithium additive including lithium nitrate (LiNO₃), lithium sulfate (Li₂SO₄) or combinations thereof.

In one or more embodiments, the interlayer may include a solid electrode interface (SEI).

In one or more embodiments, a thickness of the interlayer may be about 1 micrometer (μm) to about 30 μm.

One or more embodiments of the present disclosure provide a method of making an interlayer for an anodeless all-solid-state battery including: providing a carbonaceous material, a metal compound, and a binder to form a slurry; mixing the slurry; providing a current collector and applying the slurry to the current collector; heat treating the slurry and providing an interlayer, the heat treating including a temperature of about 100° C. to about 150° C. and a drying time of about 0.1 hour (h) to about 48 h.

In one or more embodiments, the heat treating of the slurry may include reducing at least a portion of the metal compound and providing nanoparticles including an elemental metal form of metal ions of the metal compound.

In one or more embodiments, the drying time of the heat treating may select a molar ratio (R1) of the metal compound to the nanoparticles and R1 may be about 100:1 to about 3:1.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

The preceding and other objects and features of embodiments of the present disclosure will become more apparent to those of ordinary skill in the art by describing example embodiments thereof in more detail with reference to the accompanying drawings. In the drawings:

FIG. 1 is a cutaway perspective view schematically showing a rechargeable lithium battery according to one or more embodiments.

FIG. 2 is a cross-sectional view schematically showing a rechargeable lithium battery according to one or more embodiments.

FIG. 3 and FIG. 4 are perspective views schematically showing rechargeable lithium batteries according to one or more embodiments.

FIG. 5 is a schematic view of an anodeless battery including an interlayer according to one or more embodiments of the present disclosure.

FIG. 6A and FIG. 6B are charts of lithium plating and stripping performance of anodeless all-solid-state batteries including an interlayer according to one or more embodiments of the present disclosure.

FIG. 7 and FIG. 8 are charts of electrochemical performance of anodeless all-solid-state batteries including an interlayer according to one or more embodiments of the present disclosure.

FIG. 9A and FIG. 9B are charts of electrochemical impedance spectroscopy analysis of anodeless all-solid-state batteries including an interlayer according to one or more embodiments of the present disclosure.

### DETAILED DESCRIPTION

In order to sufficiently understand the configuration and effect of embodiments of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, numbers, acts, tasks, elements, and/or a (e.g., any suitable) combination thereof.

In one or more embodiments, the term “layer” herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 200 particles at random in a transmission electron microscopic image.

The preceding and other objects and features of embodiments of the present disclosure will become more apparent to those of ordinary skill in the art by describing example embodiments thereof in more detail with reference to the accompanying drawings. In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

The following description includes non-limiting examples of values for quantities that are a part of the present disclosure. The example values are described as example ranges for the quantities and it will be understood that any and all of the following example ranges may include any sub-range beginning and/or ending with any value thereof. An example range of “about 60% to about 80%” may also include, for example, about 60.0% to about 75%, about 68% to about 80.0%, about 68% to about 72%, about 69.5% to about 70.5%, about 70.0%, and about 70%.

### Interlayer for Anodeless Battery

An anodeless battery according to one or more embodiments of the present disclosure may be an anodeless all-solid-state battery (ASSB), such as an anodeless all-solid-state lithium metal battery (ASSLMB), but the present disclosure is not limited thereto. The term “anodeless battery” as used herein is a battery that excludes a permanent anode (e.g., negative electrode) and may include a plated anode (e.g., negative electrode) that is a transient structure, as described in more detail elsewhere herein. The ASSLMB of embodiments of the present disclosure may be rechargeable and may be applied in vehicles, electric vehicles, mobile phones, electronic devices, and/or the like but the present disclosure is not limited thereto.

The anodeless battery of the present disclosure includes an interlayer having favorable ductility properties that includes at least one additive that may be a metal compound, nanoparticles, or a combination thereof.

The metal compound may be a metal salt, (e.g., an inorganic metal salt), including metal ions. In one or more embodiments, the metal compound may be substantially free of (e.g., exclude) reduced metal ions such that the entirety of the metal ions are oxidized (e.g., unreduced). For example, an oxidation state of each metal ion of the metal compound may be no less that oxidation state of the metal ions of the metal compound. In other words, all of the metal ions of the metal compound may be completely oxidized.

The metal compound may be represented by formula MₓA_{y}, where x and y are integers independently selected from 1 to 6, and M may be a metal ion including silver (Ag), zinc (Zn), indium (In), tin (Sn), bismuth (Bi), magnesium (Mg), aluminum (Al), or a combination thereof. A in formula MₓA_{y}, may be an anion such as an oxyanion, a nonmetal anion and/or the like, but the present disclosure is not limited thereto. In one or more embodiments, A may be nitrate (NO₃⁻), sulfate (SO₄²⁻), iodide (I⁻), chloride (Cl⁻), fluoride (F⁻), or a combination thereof.

In one or more embodiments, the metal compound may be selected from among silver nitrate (AgNO₃), zinc nitrate (Zn(NO₃)₂), silver sulfate (Ag₂SO₄), zinc sulfate (ZnSO₄), silver iodide (AgI), zinc iodide (ZnI₂), silver chloride (AgCl), and zinc chloride (ZnCl₂).

The nanoparticles may be a chemically reduced portion of the metal compound and another (second) portion of the metal compound remains unreduced in the additive of the interlayer. The chemically unreduced (second) portion of the metal compound may be converted into ductility promoters during operation of the battery as described in more detail herein. In one or more embodiments, the additive includes the metal compound and the nanoparticles and a molar ratio (R1) of the metal compound to the nanoparticles may be about 100:1 to about 3:1. For example, R1 may be about 90:1 to about 3:1, about 50:1 to about 3:1, about 30:1 to about 4:1, about 25:1 to about 5:1, about 24:1 to about 6:1, about 22:1 to about 7:1, about 20:1 to about 8:1, about 19:1 to about 10:1, or about 18:1 to about 15:1.

The anodeless battery of the present disclosure includes a solid electrolyte interface (SEI) that may forms during initial charging, e.g., on the negative electrode current collector, the electrolyte, and/or the interlayer. The SEI may result from decomposition of the electrolyte to provide intermediates that react with components of the interlayer and may include a multi-layered film with organic compounds and inorganic compounds such as Li₂CO₃, Li₂O, LiF, and/or the like, but the present disclosure is not limited thereto. The SEI facilitates lithium ion transport and may be a protective passivation layer that reduces or prevents further decomposition of the electrolyte that could result in undesirable side reactions, capacity loss, and potential safety hazards, e.g., dendrite formation and short circuits. The SEI may improve or enhance the stability, and structural and/or chemical integrity, to improve the lifespan, performance, and safety of the anodeless battery of the present disclosure.

### Ductility

In one or more embodiments, the SEI may be a ductile SEI having a multi-ductility mechanism provided by ductile SEI components, e.g., ductility promoters, that enhance or increase the ductility (e.g., ductile properties) of the interlayer. The term “ductility” as used herein is a physical property that allows a material to be stretched or otherwise deformed without breaking. For example, ductility may be provided by metallic bonding that includes delocalized electrons and metal crystal structures (e.g., face-centered cubic, body-centered cubic) configured for movement and stretching, but the present disclosure is not limited thereto.

The ductility promoters of the present disclosure have favorable ductile properties including metallic ductility, ionic crystal ductility, ceramic ductility, or combinations thereof each of which may accommodate volume expansion to reduce or prevent crack propagation. The term “metallic ductility” as used herein is a physical property that allows a material to simultaneously accommodate volume expansion and provide electronic conductivity. The term “ionic crystal ductility” as used herein is a physical property that allows nanoscale movement and stretching of a material. The term “ceramic ductility” as used herein is a physical property that allows nanoscale plastic deformation of a material via diffusional flow or borrowed dislocations from other materials. The metallic ductility, ionic crystal ductility, and/or ceramic ductility of the ductility promoters may provide multi-ductility mechanisms to the interlayer of the present disclosure.

In one or more embodiments, the ductility promoters may each have greater ductility than the ductility of lithium oxide. Not wishing to be limited by any particular mechanism or theory, lithium oxide is a ceramic material having ductility and plasticity that increase significantly at temperatures greater than about 350° C.

In one or more embodiments, the ductility promoters may each have a shear modulus less than a shear modulus of lithium oxide. For example, the shear modulus of each (e.g., any) ductility promoter may be about 20 gigapascal (GPa) to about 120 GPa, about 25 GPa to about 100 GPa, about 30 GPa to about 90 GPa, about 35 GPa to about 85 GPa, about 40 GPa to about 50 GPa.

In one or more embodiments, the metal compound may be configured to form, during operation of the battery, the ductility promoters that may be selected from among a lithium metal alloy, at least one lithium compound, a reduced compound, and combinations thereof. For example, the unreduced portion of the metal compound is a source for forming the ductile phase.

The lithium metal alloy may be represented by formula Li-M^{AL} and M^{AL} is a metal that may be a reduction product of the metal ion M in the metal compound of the additive as described herein. For example, M^{AL} may be silver (Ag), zinc (Zn), indium (In), tin (Sn), bismuth (Bi), magnesium (Mg), aluminum (Al), or a combination thereof.

The lithium metal alloy may have metallic ductility, ionic crystal ductility, ceramic ductility, or combinations thereof.

The lithium compound may be represented by formula LiₐA_{b} and A of formula LiₐA_{b} is an anion as described for formula MₓA_{y} and a and b may be integers independently selected from 1 to 6. For example, the lithium compound may be substantially free of (e.g., exclude) reduced anion (A) such that the entirety of A in the lithium compound may be completely oxidized.

The lithium compound may be represented by formula LiₘBₙ and B may be a be a reduction product of the anion A of formula MₓA_{y} and m and n may be integers independently selected from 1 to 6.

The lithium compound may have ionic crystal ductility, ceramic ductility, or combinations thereof.

The reduced compound may be represented by formula MₚB_{q} where M is a metal ion as described for M in the metal compound of the additive. B may be a reduction product of the anion A of formula MₓA_{y} and p and q may be integers independently selected from 1 to 6.

The lithium compound may have ionic crystal ductility, ceramic ductility, or combinations thereof.

In one or more embodiments, B may be an anion including nitride (N³⁻), sulfide (S²⁻), iodide (I⁻), chloride (Cl⁻), fluoride (F⁻), or a combination thereof.

In one or more embodiments, the reduced compound may include Ag₃N, Zn₃N₂, InN, Sn₃N₄, BiN, Mg₃N₂, AlN, Ag₂S, ZnS, In₂S₃, SnS₂, Bi₂S₃, MgS, Al₂S₃, AgF, ZnF₂, InF₃, SnF₄, BiF₃, MgF₂, AlF₃, AgCl, ZnCl₂, InCl₃, SnCl₄, BiCl₃, MgCl₂, AlCl₃, AgI, ZnI₂, InI₃, SnI₄, BiI₃, MgI₂, AlI₃, or a combination thereof. For example, Ag₂S, Li₂S, LiI, LiCl, or a combination thereof have ionic crystal ductility ceramic ductility, or combinations thereof.

In one or more embodiments, the metal compound may be silver sulfate (Ag₂SO₄) and during operation of the anodeless battery the Ag₂SO₄ forms a lithium-silver (Li—Ag) alloy, lithium sulfate (Li₂SO₄), lithium sulfide (Li₂S), silver sulfide (Ag₂S), or combinations thereof. The Li—Ag alloy may be configured to increase the metallic ductility of the interlayer, and the Li₂S and the Ag₂S may independently be configured to simultaneously increase ceramic ductility and ionic conductivity of the interlayer.

In one or more embodiments, the lithium-metal alloy may be Li—Ag, Li—Zn, and/or Li—In that increase both (e.g., simultaneously) the electronic conductivity and metallic ductility of the interlayer to accommodate volume expansion of the anode.

In one or more embodiments, the lithium compound may be Li₃N that increases the ionic conductivity of the interlayer to provide fast lithium ion transport channels in the interlayer.

In one or more embodiments, the lithium compound may be Li₂S and the reduced compound may be Ag₂S that each independently increase the ionic crystal ductility and/or ceramic ductility of the interlayer to reduce or prevent cracking.

In one or more embodiments, the lithium compound may be LiCl and/or Lil having soft anions that may increases increase both (e.g., simultaneously) ductility and interfacial contact and adherence properties of the interlayer.

In one or more embodiments, the lithium compound may be LiF having high structural stability that suppresses formation of dendrites.

### Nanoparticles

In one or more embodiments, the nanoparticles may include a metal that is a reduction product of the metal compound of the additive as described herein. For the example, the nanoparticles may consist of elemental metal produced by complete reduction of the metal compound. In one or more embodiments, the nanoparticles may include the lithium metal alloy represented by formula Li-M^{AL}.

In one or more embodiments, the nanoparticles may be metal nanoparticles on the carbonaceous material and may enhance or increase the electronic conductivity of the interlayer and at least a portion of the metal compound is unreduced and is on the carbonaceous material.

In one or more embodiments, the nanoparticles may be or include silver (Ag), zinc (Zn), indium (In), tin (Sn), bismuth (Bi), magnesium (Mg), aluminum (Al), alloys of at least two thereof, and/or combinations thereof. In one or more embodiments, the nanoparticles may include elements other than silver (Ag), zinc (Zn), indium (In), tin (Sn), bismuth (Bi), magnesium (Mg), and aluminum (Al) in at most 100 parts per million (ppm), e.g., about 1 ppm to about 50 ppm, or about 5 ppm to about 30 ppm.

In one or more embodiments, an average particle diameter (D50) of the nanoparticles may be at least about 5 nanometer (nm), but the present disclosure is not limited thereto. For example, the average particle diameter (D50) of the nanoparticles may be about 5 nm to about 500 nm, about 10 nm to about 300 nm, about 20 nm to about 150 nm, about 25 nm to about 100 nm, about 25 nm to about 70 nm, about 20 nm to about 60 nm, about 35 nm to about 60 nm, about 40 nm to about 60 nm, about 45 nm to about 6 nm, or about 50 nm to about 60 nm.

In one or more embodiments, the interlayer includes a binder that may be a liquid and/or solid and may be water-miscible, water-soluble, soluble in non-aqueous organic solvents, or a combination thereof, but the present disclosure is not limited thereto. The binder may be or include a polyvinyl alcohol (PVA) composition that may be a hydrolysis product of polyvinyl acetate (PVAA). The PVA composition may be a hydrolyzed PVAA having a degree of hydrolysis of about 50% to about 99.8%, about 70% to about 99.5%, or about 88% to about 99%. In one or more embodiments, the PVA composition may have at least about 50 mol % of hydroxyl groups, based on a total moles of the binder (e.g., the PVA composition). For example, the PVA composition may have about 50 mol % to about 99.8 mol %, about 70 mol % to about 99.5 mol %, or about 88 mol % to about 99 mol % of hydroxyl groups, based on a total moles of the binder (e.g., the PVA composition).

In one or more embodiments, the binder may further include polyethylene glycol, polypropylene glycol, polydimethylsiloxane or combinations thereof, in addition to the PVA composition.

In one or more embodiments, the polymer composition (e.g., PVA composition) may have an average molecular weight of at least about 10,000 g/mol, but the present disclosure is not limited thereto. For example, the average molecular weight of the PVA composition may be about 10 kg/mol to about 800 kg/mol, about 80 kg/mol to about 300 kg/mol, about 130 kg/mol to about 170 kg/mol, or about 140 kg/mol to about 160 kg/mol.

In one or more embodiments, the polymer composition (e.g., PVA composition) may have a density of about 1.33 grams per cubic centimeter (g/cc), but the present disclosure is not limited thereto. For example, the density of the PVA composition may be about 0.9 g/cc to about 1.8 g/cc, about 1 g/cc to about 1.5 g/cc, about 1.1 g/cc to about 1.4 g/cc, or about 1.20 g/cc to about 1.30 g/cc.

The interlayer includes a carbonaceous material may include amorphous carbon, graphite, graphene, reduced graphene oxide, carbon nanotube, combinations thereof, and/or the like, but the present disclosure is not limited thereto. In one or more embodiments, the carbonaceous material may be or include carbon powder.

In one or more embodiments, the interlayer includes about 1 wt % to about 99.5 wt %, about 5 wt % to about 95 wt %, about 5 wt % to about 80 wt %, about 5 wt % to about 60 wt %, about 70 wt % to about 90 wt %, or about 80 wt % to about 95 wt % of the carbonaceous material, based on a total weight of the interlayer.

In one or more embodiments, the interlayer includes about 0.01 wt % to about 99 wt %, about 0.1 wt % to about 50 wt %, about 0.1 wt % to about 20 wt %, about 1 wt % to about 10 wt %, about 5 wt % to about 30 wt %, or about 5 wt % to about 20 wt %, of the at least one metal additive, based on a total weight of the interlayer.

In one or more embodiments, the interlayer includes about 0.01 wt % to about 99 wt %, about 0.1 wt % to about 50 wt %, about 1 wt % to about 30 wt %, about 5 wt % to about 15 wt %, or about 8 wt % to about 10 wt % of the water-soluble binder, based on a total weight of the interlayer.

In one or more embodiments, the interlayer may be or include a matrix (e.g., nanocomposite matrix) that includes the at least one metal additive and the carbonaceous material. For example, the matrix (e.g., nanocomposite matrix) may be a matrix of the carbonaceous material and the at least one metal additive may be embedded in the matrix.

In one or more embodiments, the interlayer may be substantially free of (e.g., may exclude) organic amine compounds.

In one or more embodiments, the anodeless battery may include a lithium additive that is configured to provide additional lithium ions during an initial charging process of the anodeless battery. For example, the additional lithium ions may increase or enhance an initial coulombic efficiency of the anodeless battery. In one or more embodiments, the interlayer may include the lithium additive that may include lithium nitrate (LiNO₃), lithium sulfate (Li₂SO₄) or combinations thereof. The interlayer may include about 0.01 wt % to about 20 wt %, about 0.1 wt % to about 10 wt %, about 0.5 wt % to about 5 wt %, or about 0.5 wt % to about 1 wt % of the lithium additive, based on a total weight of the interlayer.

In one or more embodiments, a thickness of the nanocomposite interlayer may be about 1 micrometer (μm) to about 30 μm. For example, the thickness of the nanocomposite interlayer may be about 1 μm to about 25 μm, about 2 μm to about 20 μm, about 3 μm to about 15 μm, or about 4 μm to about 12 μm.

### Features of Anodeless Battery

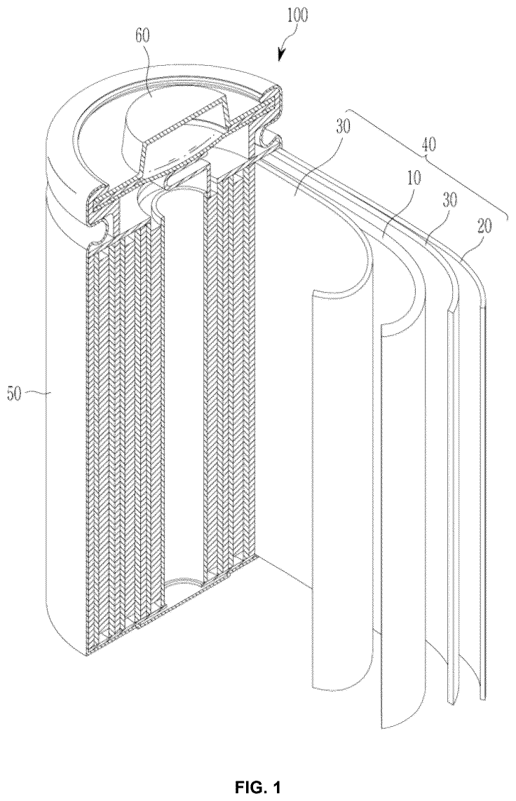

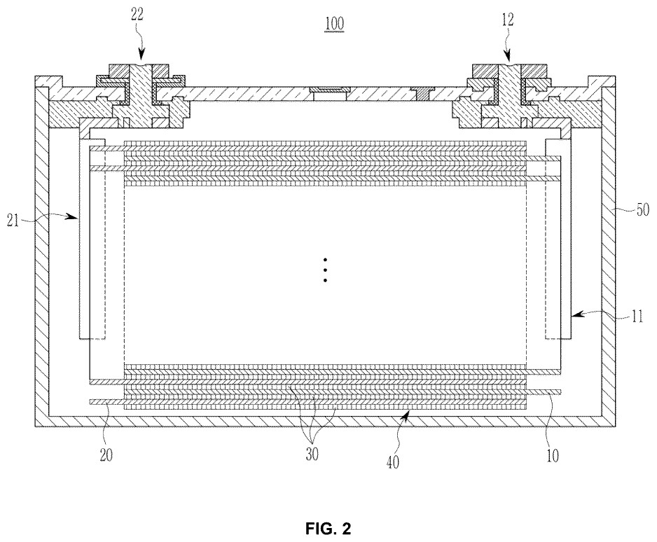

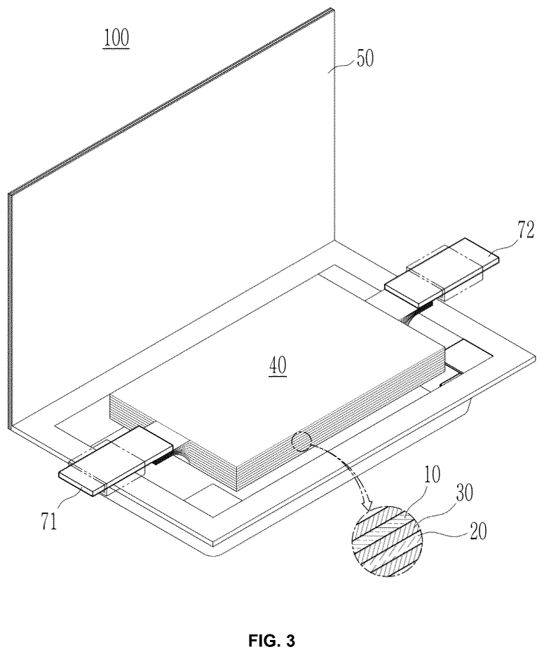

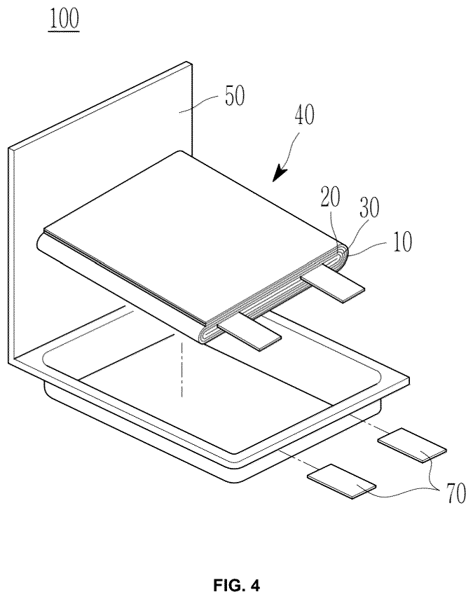

The anodeless battery according to one or more embodiments of the present disclosure may be classified into cylindrical, prismatic, pouch, coin, and/or the like, depending on the shape of the rechargeable lithium battery. FIGS. 1-4 are schematic diagrams showing the anodeless battery according to one or more embodiments, where FIG. 1 is a cylindrical battery, FIG. 2 is a prismatic battery, and FIGS. 3-4 are each a pouch-shaped battery. Referring to FIGS. 1-4, the anodeless battery 100 includes an electrode assembly 40 with a separator 30 between the positive electrode (cathode) 10 and the negative electrode (anode) 20, and a case 50 in which the electrode assembly 40 is housed. The positive electrode (cathode) 10, the negative electrode (anode) 20, and the separator 30 may be impregnated with an electrolyte. The anodeless battery 100 may include a sealing member 60 that seals the case 50 as shown in FIG. 1. In FIG. 2, the anodeless battery 100 may include a positive electrode (cathode) lead tab 11, a positive terminal 12, a negative electrode (anode) lead tab 21, and a negative terminal 22. As shown in FIGS. 3-4, the anodeless battery 100 includes electrode tabs 70, that may be a positive electrode (cathode) tab 71 and a negative electrode (anode) tab 72, that serve as an electrical path to induce the current formed in the electrode assembly 40 to the outside.

The anodeless battery includes a positive electrode having a positive electrode active material (e.g., cathode active material (CAM)). In one or more embodiments, CAM may be a nickel composite oxide (e.g., layered nickel composite oxide) including nickel, oxygen, and about one to about five elements selected from among aluminum (Al), boron (B), cobalt (Co), iron (Fe), magnesium (Mg), manganese (Mn), titanium (Ti), tungsten (W), and/or a (e.g., any suitable) combination thereof. In one or more embodiments, the CAM may be a lithium nickel composite oxide, a lithium nickel-cobalt-aluminum composite oxide (NCA-based composite oxide), and/or a lithium nickel-manganese-cobalt-based composite oxide (NMC-based composite oxide). The term “based composite oxide,” as used herein, is a CAM oxide material that includes elements (e.g., metal elements) in addition to the elements in the name of the CAM. In one or more embodiments, the CAM may be lithium nickel oxide (LiNiO₂), lithium nickel cobalt aluminum oxide (NCA) (LiNiCoAlO₂), lithium nickel manganese cobalt oxide (NMC) (LiNiCoMnO₂), or a (e.g., any suitable) combination thereof. For example, the nickel composite oxide may be at least one selected from among LiNi_{0.94}Co_{0.02}A_{0.04}O₂ (NCA94), LiNi_{0.85}Co_{0.10}Mn_{0.05}O₂ (NCM 851005), LiNi_{0.8}Co_{0.1}Mn_{0.1}O₂ (NCM 811), and LiNi_{0.6}Co_{0.2}Mn_{0.2}O₂ (NCM 622).

The nickel composite oxide may include a mole fraction of at least about 0.80 nickel, based on a total molar composition of the nickel composite oxide. In one or more embodiments, the mole fraction of nickel may be about 0.05 to about 0.999, about 0.80 to about 0.999, about 0.85 to about 0.99, or about 0.90 to about 0.95, based on a total molar composition of the nickel composite oxide.

The anodeless battery of the present disclosure includes a negative electrode current collector and the interlayer may be on the negative electrode current collector. The negative electrode current collector may be or include a metal foil. In one or more embodiments, the negative electrode current collector may include stainless steel, iron, nickel, manganese, copper, titanium, aluminum, or combinations thereof. In one or more embodiments, the negative electrode current collector includes an amount of unspecified trace elements of less than about 1%, e.g. about 10 ppm to about 5000 ppm.

### Electrolyte

The anodeless battery of the present disclosure includes an electrolyte between the positive electrode and the negative electrode current collector. In one or more embodiments, the interlayer of the present disclosure may be between the electrolyte and the negative electrode current collector. The electrolyte may be or include a solid-state electrolyte (e.g., all-solid electrolyte) that includes any material suitable for use as an ion conductive material. Non-limiting examples of the solid-state electrolyte may include an inorganic solid-state electrolyte, a crystalline solid-state electrolyte, an amorphous solid-state electrolyte, a polymeric solid-state electrolyte, or a combination thereof.

In one or more embodiments, the solid-state electrolyte may be a sulfide-based solid-state electrolyte, an oxide-based solid-state electrolyte, a lithium aluminum titanium phosphate (LATP) solid-state electrolyte, an anti-perovskite solid-state electrolyte, or a combination thereof. The sulfide-based solid-state electrolyte may include, for example, Li, S, and P and may optionally further include a halogen element. The sulfide-based solid-state electrolyte may be selected from sulfide-based solid-state electrolytes utilized in an electrolyte layer. For example, the sulfide-based solid-state electrolyte may have an ionic conductivity of at least about 1×10⁻⁵ Siemens per centimeter (S/cm) at room temperature. The oxide-based solid-state electrolyte may include, for example, Li, O, and a transition metal element and may optionally further include other elements. For example, the oxide-based solid-state electrolyte may be a solid-state electrolyte having an ionic conductivity of at least about 1×10⁻⁵ S/cm at room temperature. The oxide-based solid-state electrolyte may be selected from oxide-based solid-state electrolytes suitable for use in an electrolyte layer.

In one or more embodiments, the solid-state electrolyte may include at least one selected from among LiₚPSₙX, Li₂S—P₂S₅, Li₂S—P₂S₅—LiX, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, Li₂S—GeS₂, Li₂S—SiS₂—Li₃PO₄, Li₂S—SiS₂-LiₚMO_{q}, and a combination thereof. For example, X may be a halogen, Z may be Ge, Zn, or Ga, M may be P, Si, Ge, B, Al, Ga, or In, and m, n, p, and q may each independently be a positive integer. The solid-state electrolyte may include at least one compound of formula LiₚPSₙX, having p of 1 to 6, n of 1 to 5, and X may be F, Cl, Br or I. For example, the solid-state electrolyte may include Li₆PS₅F, Li₆PS₅Cl, Li₆PS₅Br, and/or Li₆PS₅I.

### Method of Making an Interlayer

Methods of making an interlayer for an anodeless all-solid-state battery according to one or more embodiments of the present disclosure include providing, to form a slurry, the at least one metal compound, carbonaceous material, and binder (e.g., water-soluble binder), each as described in more detail herein. The methods include mixing the slurry and distributing the at least one metal compound substantially uniformly within the carbonaceous material, e.g., by mixing with agitation suitable or sufficient to provide the slurry as a homogeneous and flowable slurry. For example, the slurry may be mixed in a centrifugal mixer or planetary mixer at a mixing speed of about 1000 rpm to about 5000 rpm.

The methods include applying (e.g., coating) the slurry to a current collector, e.g., a negative electrode current collector or a positive electrode current collector. The slurry may be applied with a doctor blade, but the present disclosure is not limited thereto. In one or more embodiments, the slurry may be applied using spin cast, tape casting, and/or roll-to-roll coating technology.

The methods include heat treating the slurry to dry the slurry and provide the interlayer on the negative electrode current collector. The heat treating of the slurry provides the at least one additive that includes a metal compound and/or nanoparticles, as described in more detail herein. The additive(s) and/or nanoparticles may be distributed substantially uniformly within a matrix of the carbonaceous material, as described in more detail herein. For example, the nanoparticles may be metal nanoparticles distributed on the carbonaceous material.

The conditions for heat treating the slurry may be selected to chemically reduce at least a portion (first portion) of the metal compound such that at least another (second) portion of the metal compound remains unreduced to provide the additive of the interlayer. The chemically reduced portion (first portion) of the metal compound provides the nanoparticles including an elemental metal form of the metal ions of the metal compound. The chemically unreduced portion (second portion) of the metal compound provides the ductility promoters during operation of the battery and may be on the carbonaceous material.

The extent of chemical reduction (EOR) of the metal compound is an amount of the metal compound that is chemically reduced with respect to a total amount of the metal compound. The FOR of the metal compound may be selected by the drying time and/or the drying (heat treating) temperature. For example, when the FOR of the metal compound is less than 100% the additive includes both (e.g., simultaneously) the metal compound and the nanoparticles. The FOR of the metal compound may be about 1% to about 99%, about 30% to about 95%, or about 60% to about 93%.

In some embodiments, a molar ratio (R1) of the metal compound to the nanoparticles in the least one additive of the interlayer may be selected by the drying time and/or the temperature. R1 may be about 90:1 to about 3:1, about 50:1 to about 3:1, about 30:1 to about 4:1, about 25:1 to about 5:1, about 24:1 to about 6:1, about 22:1 to about 7:1, about 20:1 to about 8:1, about 19:1 to about 10:1, or about 18:1 to about 15:1.

The slurry may be heat treated at a temperature of about 40° C. to about 1000° C., about 80° C. to about 200° C., about 100° C. to about 150° C., or at about 120° C.

The slurry may be heat treated for about 5 minutes to about 3 days, about 0.25 hour (h) to about 60 h, about 0.5 h to about 36 h, about 1 h to about 24 h, about 2 h to about 20 h, about 3 hour to about 8 h, about 0.6 h to about 2 h, about 0.7 h to about 1.5 h, or about 0.8 h to about 1.2 h.

In one or more embodiments, if (e.g., when) the drying time is about 0.6 h to about 2 h, about 0.7 h to about 1.5 h, or about 0.8 h to about 1.2 h, and the drying temperature is about 100° C. to about 150° C., or about 115° C. to about 125° C., then R1 may be about 19:1 to about 10:1, or about 18:1 to about 15:1, and the FOR of the metal compound may be about 60% to about 99%, or about 80% to about 97%.

In one or more embodiments, the slurry includes about 1 wt % to about 99.5 wt %, about 5 wt % to about 95 wt %, about 5 wt % to about 80 wt %, about 5 wt % to about 60 wt %, about 10 wt % to about 50 wt %, or about 40 wt % to about 90 wt % of the carbonaceous material, based on a total weight of the slurry.

In one or more embodiments, the slurry includes about 0.01 wt % to about 99 wt %, about 0.1 wt % to about 50 wt %, about 0.1 wt % to about 20 wt %, or about 5 wt % to about 20 wt % of the at least one metal additive, based on a total weight of the slurry.

In one or more embodiments, the slurry includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt % of the water-soluble binder, based on a total weight of the slurry.

The methods of embodiments of the present disclosure include a single act process to provide an interlayer including the additive in a matrix of the carbonaceous material.

The methods of the present disclosure exclude chemical additives such as organic amine compounds, oxidants, reductants, stabilizers and/or the like.

### Method of Operating an Anodeless Battery

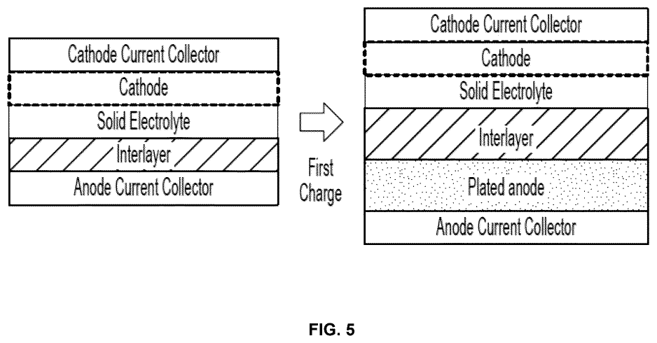

Methods of operating the anodeless battery according to one or more embodiments of the present disclosure include providing a plated anode in the anodeless battery. FIG. 5 shows the interlayer on the anode (e.g., negative electrode) current collector before charging and the plated anode on the anode (e.g., negative electrode) current collector after the first charge, and between the interlayer and the anode (e.g., negative electrode) current collector of the anodeless battery.

The methods may include operating an anodeless all-solid-state battery (ASSB) to provide a plated anode in the ASSB, and/or operating an all-solid-state lithium metal battery (ASSLMB) to provide a plated anode in the ASSLMB.

In one or more embodiments, the plated anode may include metal elements, metal alloys, metal compounds, or a combination thereof. For example, the plated anode may include lithium metal, lithium alloys, lithium compounds, or combinations thereof. The metal (e.g., lithium metal) that is plated on the anode (e.g., negative electrode) current collector may migrate from a component of the anodeless battery. The metal (e.g., lithium metal) may migrate from the cathode active material of the positive electrode, from the solid-state electrolyte, or combinations thereof.

The methods may include discharging the anodeless battery to remove the plated anode.

Hereinafter, referring to examples and comparative examples, the interlayer according to one or more embodiments and an anodeless battery according to one or more embodiments of the disclosure are described in more detail. In some embodiments, the following examples are intended to assist understanding of the disclosure, and the scope of the disclosure is not limited thereto.

### EXAMPLES

### Preparation of Composite Solid-State Electrolytes

Table 1 displays the properties of the raw materials used to prepare the polymer compositions of Examples 1.1 to 1.3, 2.1 to 2.4 and Comparative Examples 1 to 3 according to embodiments of the present disclosure.

TABLE 1

| | Mol. Wt. | Density | |
|---|---|---|---|
| | (g/mol) | (g/cc) | Supplier |
| carbon powder | 12 g/mol | about 2.0 | Cabot Corp. |
| AgNO₃ | 169.87 | about 4.35 | Fisher Scientific Inc. |
| polyvinyl alcohol | 150,000 | about 1.30 | Sigma Aldrich |

### Example 1.1

Example 1.1 was prepared by adding carbon powder (0.700 gram (g)), AgNO₃ (0.16535 g), and polyvinyl alcohol (PVA, 0.875 g, 8 wt % solution) in 800 mg of deionized water followed by mixing at 2000 rpm for 3 min (ARE-310 THINKY USA INC.) to generate a homogeneous and flowable slurry. The slurry was applied to a Ni/Cu foil (current collector, LOTTE Chemical), using doctor blade conditions including a 10 micrometer (μm) gap at a speed of 0.5 centimeter per second (cm/s) (Elcometer), and heat treated at a temperature of 120° C. for 1 hour (h) to provide an interlayer including a majority of unreduced AgNO₃ and a minor portion of metallic silver particles.

### Example 1.2

Example 1.2 is an interlayer prepared using substantially the same method as Example 1.1 except that the applied slurry was heat treated at a temperature of 120° C. for 24 hour (h) to provide an interlayer including metallic silver particles.

### Comparative Example 1

Comparative Example 1 is an interlayer prepared using substantially the same method as Example 1.2 except that AgNO₃ was not added.

### Evaluation of Composition

The extent of reduction (conversion) of silver cation to metallic silver nanoparticles was determined based on a total weight of the interlayer. The nanoparticles were analyzed by with X-ray powder diffraction (XRD) analysis to determine average particle diameter. The results are shown in Table 2.

TABLE 2

| | Example | Example | Comparative |
|---|---|---|---|
| | 1.1 | 1.2 | Example 1 |
| AgNO₃ conversion to Ag (s) (%) | 15 | 100 | N/A |
| Unreduced salt (wt %) | 85 | 0 | N/A |
| Ratio: salt to metal | 17:1 | N/A | N/A |
| Nanoparticle diameter (nm) | 40.3 | 46.9 | N/A |
| Areal loading (mg/cm²) | 0.85 | 0.96 | 1.17 |
| Thickness (μm) | 10.3 | 12.0 | 14.3 |
| Density (g/cc) | 0.82 | 0.8 | 0.82 |

The results shown in Table 2 suggest that the conversion of silver cation and the average particle size of the nanoparticles increased with greater heat treating time.

### Evaluation of Electrochemical Performance

Anodeless all-solid-state battery torque half-cells were assembled using the negative electrode current collectors with interlayers prepared in Examples 1.1 and 1.2. The half-cells were charged at a rate of 0.1 milliampere per square centimeter (mA/cm²) for a total of 1.5 milliampere hour per square centimeter (mAh/cm²).

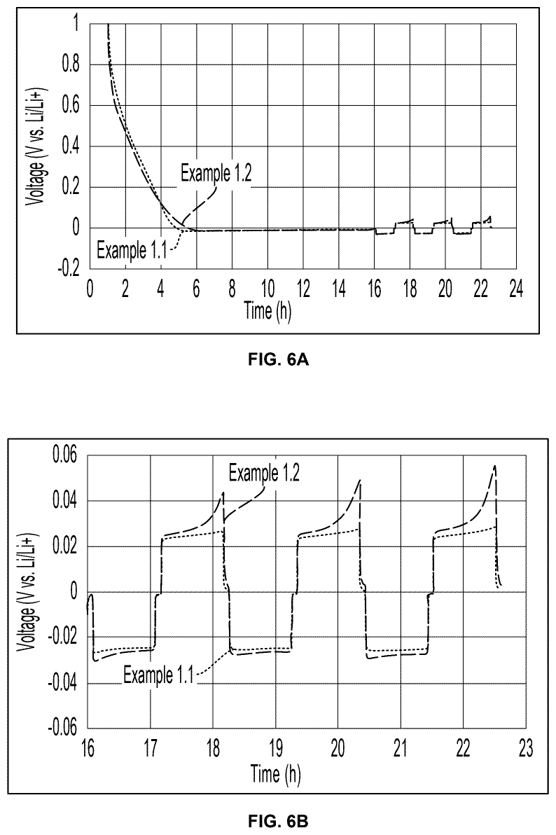

FIGS. 6A-6B display the electrochemical lithium plating and stripping performance of Examples 1.1 and 1.2 while cycling at 0.5 mA/cm² for a total of 0.5 mAh/cm². The results in FIGS. 6A-6B show that the unreduced AgNO₃ in the interlayer of Example 1.1 provided superior stable plating and stripping and a less polarized voltage profile, which suggest that the interlayer have enhanced or improved lithium ion kinetics.

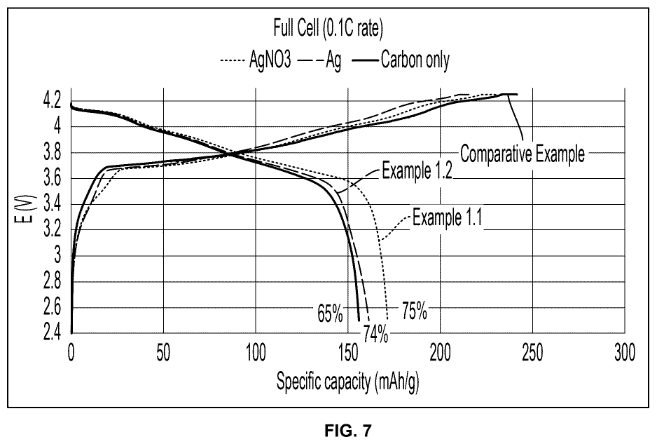

FIG. 7 displays the results of electrochemical performance of anodeless all-solid-state battery torque full-cells that were assembled with an NCA cathode using the negative electrode current collectors with interlayers prepared in Examples 1.1 and 1.2 and Comparative Example 1. Coulombic efficiency was measured at 25° C. with a current density of 0.1 C. The results in FIG. 7 show that the unreduced AgNO₃ in the interlayer of Example 1.1 provided superior coulombic efficiency.

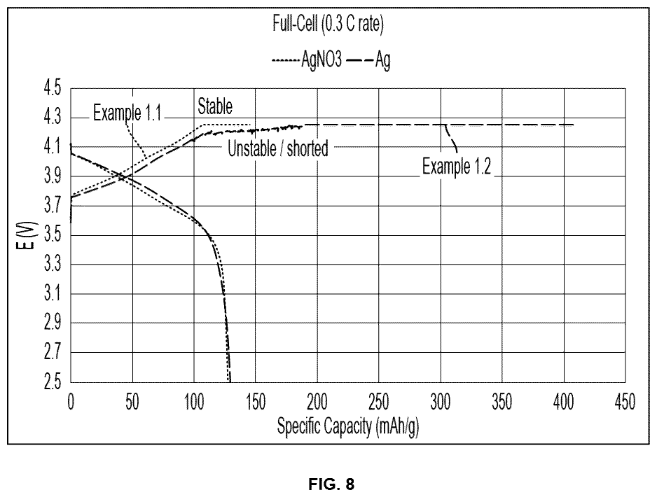

FIG. 8 displays the results of electrochemical performance of the torque full-cells that were assembled from the interlayers prepared in Examples 1.1 and 1.2. Coulombic efficiency was measured at 25° C. with a current density of 0.3 C. The results in FIG. 8 show that the unreduced AgNO₃ in the interlayer of Example 1.1 provided superior stable cycling performance whereas Example 1.2 displayed unstable, micro-shorted performance.

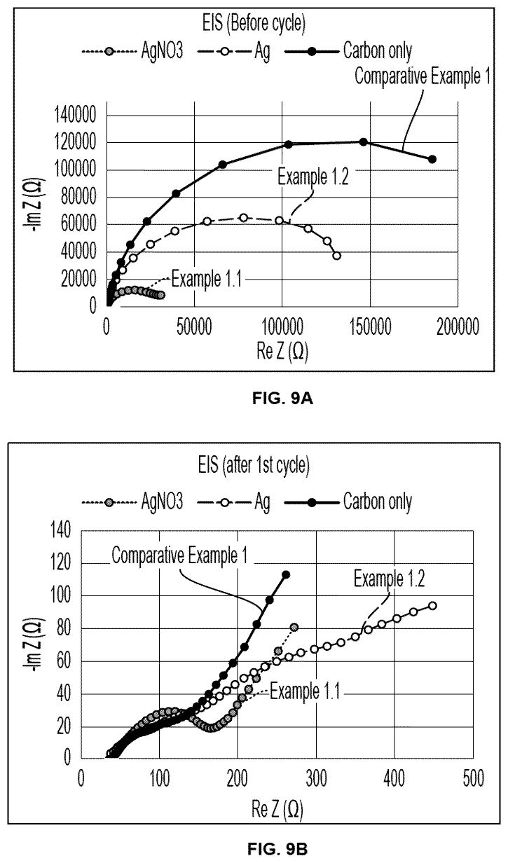

FIGS. 9A-9B display the results of electrochemical impedance spectroscopy (EIS) analysis before cycling and after the first cycle (0.1C), respectively, for the torque full-cells that were assembled from interlayers prepared in Examples 1.1 and 1.2 and Comparative Example 1.

The results in FIG. 9A show that the unreduced AgNO₃ in the interlayer of Example 1.1 provided superior (e.g., lowest) resistance before the first charge (at rest).

The results in FIG. 9B show that a solid electrolyte interface (SEI) was formed for the interlayer of Example 1.1, as evidenced by a semi-circle with a reactance (Rct) of about 110 Ohm. FIG. 9B has no evidence that SEI was formed in Example 1.2 and Comparative Example 1.

The preceding results demonstrate that the methods of the present disclosure include mild heat treating to provide an interlayer having metal nanoparticles and an unreduced metal compound that provides ductility promoters with lithium during the initial charging process of the anodeless battery. The methods of the present disclosure exclude, or do not otherwise require, the use of organic amine additives to manufacture the interlayer. The methods of embodiments of the present disclosure are suitable for scalable manufacturing processes.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

What is claimed is:

1. An anodeless battery comprising:
a positive electrode;
a negative electrode current collector;
a solid-state electrolyte between the positive electrode and the negative electrode current collector; and
an interlayer between the solid-state electrolyte and the negative electrode current collector and comprising at least one additive, a carbonaceous material, and a binder,
the additive comprising a metal compound, nanoparticles, or a combination thereof, the metal compound represented by formula MₓA_{y} and the nanoparticles comprising a metal represented by M of formula MₓA_{y},
wherein
in formula MₓA_{y}, x and y are integers independently selected from 1 to 6,
M is silver (Ag), zinc (Zn), indium (In), tin (Sn), bismuth (Bi), magnesium (Mg), aluminum (Al), or a combination thereof, and
A is nitrate (NO₃⁻), sulfate (SO₄²⁻), iodide (I⁻), chloride (Cl⁻), fluoride (F⁻), or a combination thereof,
the interlayer is substantially free of organic amine compounds, and
the anodeless battery is an anodeless all-solid-state battery.

2. The anodeless battery as claimed in claim 1, wherein the additive comprises the metal compound and the nanoparticles and a molar ratio (R1) of the metal compound to the nanoparticles is about 100:1 to about 3:1.

3. The anodeless battery as claimed in claim 1, wherein the metal compound is configured to form ductility promoters comprising a lithium metal alloy, at least one lithium compound, a reduced compound, or combinations thereof,
the lithium metal alloy is represented by formula Li-M^{AL},
the lithium compound is represented by formula LiₐA_{b} or formula LiₘBₙ,
the reduced compound is represented by formula MₚB_{q},
M^{AL} is silver (Ag), zinc (Zn), indium (In), tin (Sn), bismuth (Bi), magnesium (Mg), aluminum (Al), or a combination thereof,
B is nitride (N³⁻), sulfide (S²⁻), iodide (I⁻), chloride (Cl⁻), fluoride (F⁻), or a combination thereof,
a, b, m, n, p and q are integers independently selected from 1 to 6, and
M and A are as defined in formula MₓA_{y}.

4. The anodeless battery as claimed in claim 3, wherein the metal compound is configured to form the ductility promoters during operation of the battery and increase ductile properties of the interlayer.

5. The anodeless battery as claimed in claim 4, wherein the ductility promoters have ductile properties comprising metallic ductility, ionic crystal ductility, ceramic ductility, or combinations thereof.

6. The anodeless battery as claimed in claim 5, wherein the lithium metal alloy has metallic ductility and the lithium compound, the reduced compound, or a combination thereof have ionic crystal ductility.

7. The anodeless battery as claimed in claim 1, wherein the metal compound is selected from among silver nitrate (AgNO₃), zinc nitrate (Zn(NO₃)₂), silver sulfate (Ag₂SO₄), zinc sulfate (ZnSO₄), silver iodide (AgI), zinc iodide (ZnI₂), silver chloride (AgCl), and zinc chloride (ZnCl₂).

8. The anodeless battery as claimed in claim 4, wherein the ductility promoters comprise silver sulfide (Ag₂S), lithium sulfide (Li₂S), lithium iodide (LiI), lithium chloride (LiCl), or a combination thereof.

9. The anodeless battery as claimed in claim 8, wherein the Ag₂S, Li₂S, LiI, LiCl, or a combination thereof have ionic crystal ductility.

10. The anodeless battery as claimed in claim 4, wherein the metal compound is silver sulfate (Ag₂SO₄) and is configured to form a lithium-silver (Li—Ag) alloy, lithium sulfate (Li₂SO₄), lithium sulfide (Li₂S), silver sulfide (Ag₂S), or combinations thereof,
the Li—Ag alloy is configured to increase metallic ductility of the interlayer, and
the Li₂S and the Ag₂S are independently configured to increase ceramic ductility and ionic conductivity of the interlayer simultaneously.

11. The anodeless battery as claimed in claim 1, wherein the nanoparticles consist of an elemental form of the metal having electronic conductivity and are on the carbonaceous material.

12. The anodeless battery as claimed in claim 11, wherein at least a portion of the metal compound is unreduced.

13. The anodeless battery as claimed in claim 1, wherein the carbonaceous material comprises amorphous carbon, graphite, graphene, reduced graphene oxide, carbon nanotube, or combinations thereof.

14. The anodeless battery as claimed in claim 1, wherein the interlayer comprises, based on a total weight of the interlayer:
about 1 wt % to about 50 wt % of the at least one metal additive;
about 5 wt % to about 95 wt % of the carbonaceous material; and
about 1 wt % to about 30 wt % of a water-soluble binder.

15. The anodeless battery as claimed in claim 1, wherein the interlayer comprises a lithium additive comprising lithium nitrate (LiNO₃), lithium sulfate (Li₂SO₄) or combinations thereof.

16. The anodeless battery as claimed in claim 1, wherein the interlayer comprises a solid electrode interface (SEI).

17. The anodeless battery as claimed in claim 1, wherein a thickness of the interlayer is about 1 micrometer (μm) to about 30 μm.

18. A method comprising:
providing a carbonaceous material, a metal compound, and a binder to form a slurry;
mixing the slurry;
providing a current collector and applying the slurry to the current collector;
heat treating the slurry and providing an interlayer, the heat treating comprising a temperature of about 100° C. to about 150° C. and a drying time of about 0.1 hour (h) to about 48 h,
wherein the method is a method of making an interlayer for an anodeless all-solid-state battery.

19. The method as claimed in claim 18, wherein the heat treating of the slurry comprises reducing at least a portion of the metal compound and providing nanoparticles comprising an elemental metal form of metal ions of the metal compound.

20. The method as claimed in claim 19, wherein the drying time of the heat treating selects a molar ratio (R1) of the metal compound to the nanoparticles and R1 is about 100:1 to about 3:1.
